(19) United States
(12) Patent Application Publication
(10) Pub. No.: US 2025/0133047 A1
(43) Pub. Date: Apr. 24, 2025

(54) SYSTEMS AND METHODS FOR AI-DRIVEN PRIORITIZATION OF ELECTRONIC COMMUNICATIONS

(71) Applicant: Yahoo Assets LLC, New York, NY (US)

(72) Inventor: Bassem BOUGUERRA, Long Beach, CA (US)

(21) Appl. No.: 18/493,000

(22) Filed: Oct. 24, 2023

(51) Int. Cl. H04L 51/212; H04L 51/226; H04L 51/42

(52) U.S. Cl. CPC H04L 51/212; H04L 51/226; H04L 51/42

(57) ABSTRACT

Various embodiments of this disclosure relate generally to utilizing a machine-learning model to determine an electronic communication priority. The method comprises receiving an electronic communication dataset reflecting an electronic communication inbox of a user from one or more databases, wherein the electronic communication dataset includes a plurality of electronic communications, utilizing a trained machine-learning model to determine a priority for at least one of the plurality of electronic communications based on the electronic communication dataset, wherein the priority corresponds to an importance level of the at least one of the plurality of electronic communications, filtering the electronic communication dataset according to the priority, and displaying the filtered electronic communication dataset via an electronic communication interface of a user device, wherein the electronic communication interface corresponds to an electronic communication application.

### TECHNICAL FIELD

Various embodiments of this disclosure relate generally to systems and methods for training and utilizing artificial intelligence for classifying and prioritizing electronic communications.

### BACKGROUND

Email usage is an integral method of communication for many people. However, since email usage has become incredibly popular, many people's email applications have an overwhelming amount of emails. Manually sorting and sifting through emails can be time-consuming and lead to decreased productivity. Additionally, important emails can get buried in an email inbox, leading to missed opportunities, deadlines, or urgent tasks. As a result, for many users, navigating the email application user interface, tools, and features can be an inefficient and impersonal experience. Moreover, sorting and prioritization of an email inbox is currently limited and may demand significant manual effort. For example, conventional methods for prioritizing email may include the user manually filtering and sorting through email. Conventional methods may also include applications that rely on static rules and need extensive computation resources, which may lack the flexibility to adapt to a user's changing preferences. Additionally, such conventional methods are inefficient, rigid, and limited in scope. Moreover, such conventional methods may be unable to provide a personalized experience (e.g., unable to dynamically adjust to a user's interactions with the email application). As a result, improvements for classifying and prioritizing a user's email are desired, so as to improve efficiency and the overall user email experience.

This disclosure is directed to addressing above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, embodiments are disclosed for training and utilizing artificial intelligence to classify and prioritize electronic communications.

In one aspect, an exemplary embodiment of a method for utilizing a machine-learning model to determine an electronic communication priority is disclosed. The method may include receiving, by one or more processors, an electronic communication dataset reflecting an electronic communication inbox of a user from one or more databases, wherein the electronic communication dataset includes a plurality of electronic communications, a plurality of attributes corresponding to the plurality of electronic communications, or a plurality of user interactions with the plurality of electronic communications. The method may further include utilizing, by the one or more processors, a trained machine-learning model to determine a priority for at least one of the plurality of electronic communications based on the electronic communication dataset, wherein the priority corresponds to an importance level of the at least one of the plurality of electronic communications. The method may further include filtering, by the one or more processors, the electronic communication dataset according to the priority. The method may further include displaying, by the one or more processors, the filtered electronic communication dataset via an electronic communication interface of a user device, wherein the electronic communication interface corresponds to an electronic communication application.

In one aspect, a computer system for utilizing a machine-learning model to determine an electronic communication priority is disclosed. The computer system may comprise a memory having processor-readable instructions stored therein and one or more processors configured to access the memory and execute the processor-readable instructions, which when executed by the one or more processors configures the one or more processors to perform a plurality of functions. The functions may include receiving an electronic communication dataset reflecting an electronic communication inbox of a user from one or more databases, wherein the electronic communication dataset includes a plurality of electronic communications, a plurality of attributes corresponding to the plurality of electronic communications, or a plurality of user interactions with the plurality of electronic communications. The functions may further include utilizing a trained machine-learning model to determine a priority for at least one of the plurality of electronic communications based on the electronic communication dataset, wherein the priority corresponds to an importance level of the at least one of the plurality of electronic communications. The functions may further include filtering the electronic communication dataset according to the priority. The functions may further include displaying the filtered electronic communication dataset via an electronic communication interface of a user device, wherein the electronic communication interface corresponds to an electronic communication application.

In one aspect, a non-transitory computer-readable medium containing instructions for utilizing a machine-learning model to determine an electronic communication priority is disclosed. The instructions may comprise receiving an electronic communication dataset reflecting an electronic communication inbox of a user from one or more databases, wherein the electronic communication dataset includes a plurality of electronic communications, a plurality of attributes corresponding to the plurality of electronic communications, or a plurality of user interactions with the plurality of electronic communications. The instructions may further comprise utilizing a trained machine-learning model to determine a priority for at least one of the plurality of electronic communications based on the electronic communication dataset, wherein the priority corresponds to an importance level of the at least one of the plurality of electronic communications. The instructions may further comprise filtering the electronic communication dataset according to the priority. The instructions may further comprise displaying the filtered electronic communication dataset via an electronic communication interface of a user device, wherein the electronic communication interface corresponds to an electronic communication application.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary networked computing environment that may be utilized with techniques presented herein, according to one or more embodiments.

FIG. 2 depicts a flowchart of an exemplary method for utilizing a machine-learning model to determine an electronic communication priority, according to one or more embodiments.

FIG. 3 depicts a flowchart of an exemplary method for training a machine-learning model to determine an electronic communication priority, according to one or more embodiments.

FIG. 4 depicts an example of a computing device that may execute the techniques described herein, according to one or more embodiments.

### DETAILED DESCRIPTION OF EMBODIMENTS

According to certain aspects of the disclosure, methods and systems for training and utilizing artificial intelligence (AI) to classify and prioritize electronic communications are disclosed.

Email usage is an integral method of communication for many people. However, since email usage has become incredibly popular, many people's email applications have an overwhelming amount of emails. Manually sorting and sifting through emails can be time-consuming and lead to decreased productivity. Additionally, important emails can get buried in an email inbox, leading to missed opportunities, deadlines, or urgent tasks. As a result, for many users, navigating the email application user interface, tools, and features can be an inefficient and impersonal experience. Moreover, sorting and prioritization of an email inbox is currently limited and may demand significant manual effort. For example, conventional methods for prioritizing email may include the user manually filtering and sorting through email. Conventional methods may also include applications that rely on static rules and need extensive computation resources, which may lack the flexibility to adapt to a user's changing preferences. Additionally, such conventional methods are inefficient, rigid, and limited in scope. Moreover, such conventional methods may be unable to provide a personalized experience (e.g., unable to dynamically adjust to a user's interactions with the email application). As a result, improvements for classifying and prioritizing a user's email are desired, so as to improve efficiency and the overall user email experience.

The claimed systems and methods leverage the power of AI and supervised learning to create an efficient, transparent, and personalized email classification and prioritization system. For example, by automatically categorizing emails with a priority and providing insights into the prioritization process, the disclosed systems and methods enhance a user's email management experience, ensuring that the user does not miss essential messages, while also efficiently handling email overload.

The disclosed systems and methods have many advantages, as discussed below. First, the disclosed systems and methods allow users to define rules regarding the priority of emails, which produces more personalized and accurate results. Additionally, existing email sorting systems may not take a user's specific preferences into account when prioritizing email, resulting in generic email organization. The systems and methods described personalize the email prioritization process by learning from each user's interactions and preferences, and then dynamically updating the email prioritization process. Additionally, for example, the systems and methods described may consider the tone, topic, urgency, and user interactions to accurately classify and prioritize emails.

Second, unlike conventional email sorting solutions that rely on manual rules, the systems and methods of this disclosure leverage the power of AI to label the training set. The integration of supervised learning may result in highly accurate email predictions. Furthermore, users may be able to redefine their own criteria for email prioritization, creating a personalized model that may be continuously retrained in near real-time.

Third, the disclosed systems and methods improve efficiency by leveraging AI for data augmentation and optimizing text representation. For example, conventional machine-learning models may need extensive computational resources for training and prediction. The systems and methods of this disclosure increase the user's ease of use by utilizing a LLM to receive natural language rules, and also increase efficiency by utilizing a logistic regression algorithm to apply the rules to electronic correspondence data to determine an email priority. Utilizing a LLM to receive rules input from a user allows for the user to efficiently and easily create and update rules by using natural language. Moreover, utilizing a logistic regression algorithm for determining an email priority results in efficiently and accurately creating and updating an email priority by allowing the process to occur in near real-time, while utilizing less resources.

Fourth, another advantage may include providing users with transparency in email classification by explaining why an email has a particular priority, which may offer a level of insight and understanding. For example, existing email classification systems may not provide clear explanations for why an email is marked as important. The systems and methods described in this disclosure offer transparency by allowing users to understand the reasons behind the prioritization, resulting in enhancing user trust and confidence in the system.

As will be discussed in more detail below, in various embodiments, systems and methods are described for utilizing a machine-learning model to determine an electronic communication priority. The systems and methods may include receiving, by one or more processors, an electronic communication dataset reflecting an electronic communication inbox of a user from one or more databases, wherein the electronic communication dataset includes a plurality of electronic communications, a plurality of attributes corresponding to the plurality of electronic communications, or a plurality of user interactions with the plurality of electronic communications. The systems and methods may include utilizing, by the one or more processors, a trained machine-learning model to determine a priority for at least one of the plurality of electronic communications based on the electronic communication dataset, wherein the priority corresponds to an importance level of the at least one of the plurality of electronic communications. The systems and methods may include filtering, by the one or more processors, the electronic communication dataset according to the priority. The systems and methods may include displaying, by the one or more processors, the filtered electronic communication dataset via an electronic communication interface of a user device, wherein the electronic communication interface corresponds to an electronic communication application.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In the detailed description herein, references to “embodiment,” “an embodiment,” “one non-limiting embodiment,” “in various embodiments,” etc., indicate that the embodiment(s) described can include a particular feature, structure, or characteristic, but every embodiment might not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

In general, terminology can be understood at least in part from usage in context. For example, terms, such as “and”, “or”, or “and/or,” as used herein can include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, can be used to describe any feature, structure, or characteristic in a singular sense or can be used to describe combinations of features, structures or characteristics in a plural sense. Similarly, terms, such as “a,” “an,” or “the,” again, can be understood to convey a singular usage or to convey a plural usage, depending at least in part upon context. In addition, the term “based on” can be understood as not necessarily intended to convey an exclusive set of factors and can, instead, allow for existence of additional factors not necessarily expressly described, again, depending at least in part on context.

As used herein, the terms “comprises,” “comprising,” or any other variation thereof are intended to cover a non-exclusive inclusion, such that a process, method, composition, article, or apparatus that comprises a list of elements does not include only those elements, but may include other elements not expressly listed or inherent to such process, method, composition, article, or apparatus. The term “exemplary” is used in the sense of “example” rather than “ideal.” As used herein, the singular forms “a,” “an,” and “the” include plural reference unless the context dictates otherwise. Relative terms such as “about,” “substantially,” and “approximately” refer to being nearly the same as a referenced number or value, and should be understood to encompass a variation of ±5% of a specified amount or value.

As used herein, a “model” or “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. Any suitable type of training may be used, e.g., stochastic, gradient boosted, random seeded, recursive, epoch or batch-based, etc.

Certain non-limiting embodiments are described below with reference to block diagrams and operational illustrations of methods, processes, devices, and apparatus. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

### Exemplary Environment

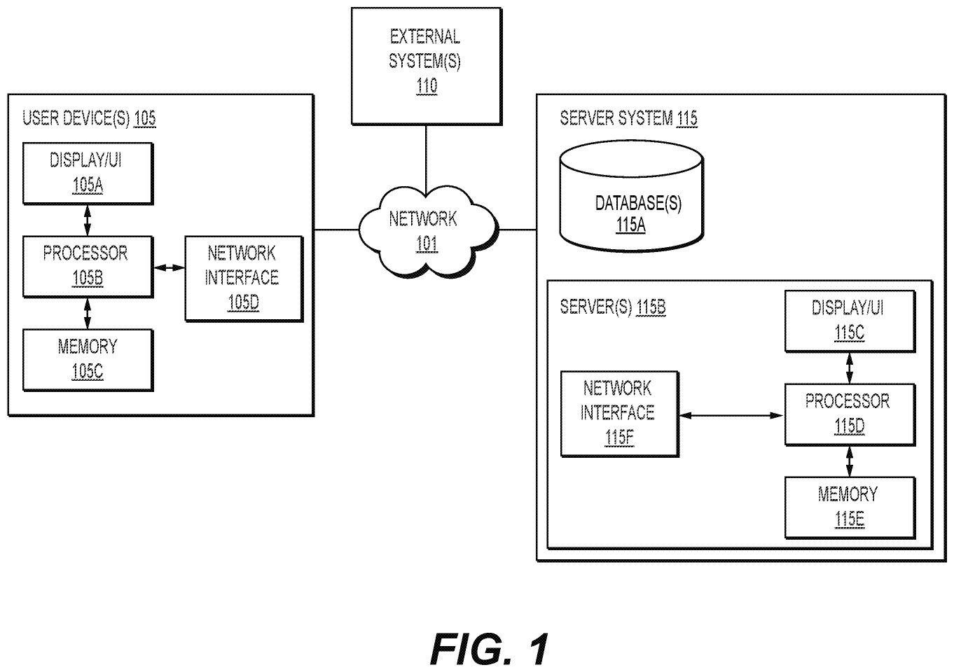

FIG. 1 depicts an exemplary environment 100 that may be utilized with techniques presented herein. One or more user device(s) 105, one or more external system(s) 110, and one or more server system(s) 115 may communicate across a network 101. As will be discussed in further detail below, one or more server system(s) 115 may communicate with one or more of the other components of the environment 100 across network 101. The one or more user device(s) 105 may be associated with a user, e.g., a user associated with one or more of generating, training, or tuning a machine-learning model to determine an electronic communication priority.

In some embodiments, the components of the environment 100 are associated with a common entity. In some embodiments, one or more of the components of the environment is associated with a different entity than another. The systems and devices of the environment 100 may communicate in any arrangement. As will be discussed herein, systems and/or devices of the environment 100 may communicate in order to one or more of generate, train, and/or use a machine-learning model to determine an electronic communication priority, among other activities.

The user device 105 may be configured to enable the user to access and/or interact with other systems in the environment 100. For example, the user device 105 may be a computer system such as, for example, a desktop computer, a mobile device, a tablet, etc. In some embodiments, the user device 105 may include one or more electronic application(s), e.g., a program, plugin, browser extension, etc., installed on a memory of the user device 105.

The user device 105 may include a display/user interface (UI) 105A, a processor 105B, a memory 105C, and/or a network interface 105D. The user device 105 may execute, by the processor 105B, an operating system (O/S) and at least one electronic application (each stored in memory 105C). The electronic application may be a desktop program, a browser program, a web client, or a mobile application program (which may also be a browser program in a mobile O/S), an applicant specific program, system control software, system monitoring software, software development tools, or the like. For example, environment 100 may extend information on a web client that may be accessed through a web browser. In some embodiments, the electronic application(s) may be associated with one or more of the other components in the environment 100. The application may manage the memory 105C, such as a database, to transmit streaming data to network 101. The display/UI 105A may be a touch screen or a display with other input systems (e.g., mouse, keyboard, etc.) so that the user(s) may interact with the application and/or the O/S. The network interface 105D may be a TCP/IP network interface for, e.g., Ethernet or wireless communications with the network 101. The processor 105B, while executing the application, may generate data and/or receive user inputs from the display/UI 105A and/or receive/transmit messages to the server system 115, and may further perform one or more operations prior to providing an output to the network 101.

External systems 110 may be, for example, one or more third party and/or auxiliary systems that integrate and/or communicate with the server system 115 in performing various natural language email instruction tasks. External systems 110 may be in communication with other device(s) or system(s) in the environment 100 over the one or more networks 101. For example, external systems 110 may communicate with the server system 115 via API (application programming interface) access over the one or more networks 101, and also communicate with the user device(s) 105 via web browser access over the one or more networks 101.

In various embodiments, the network 101 may be a wide area network (“WAN”), a local area network (“LAN”), a personal area network (“PAN”), or the like. In some embodiments, network 101 includes the Internet, and information and data provided between various systems occurs online. “Online” may mean connecting to or accessing source data or information from a location remote from other devices or networks coupled to the Internet. Alternatively, “online” may refer to connecting or accessing a network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

The server system 115 may include an electronic data system, e.g., a computer-readable memory such as a hard drive, flash drive, disk, etc. In some embodiments, the server system 115 includes and/or interacts with an application programming interface for exchanging data to other systems, e.g., one or more of the other components of the environment.

The server system 115 may include a database 115A and at least one server 115B. The server system 115 may be a computer, system of computers (e.g., rack server(s)), and/or or a cloud service computer system. The server system may store or have access to database 115A (e.g., hosted on a third party server or in memory 115E). The server(s) may include a display/UI 115C, a processor 115D, a memory 115E, and/or a network interface 115F. The display/UI 115C may be a touch screen or a display with other input systems (e.g., mouse, keyboard, etc.) for an operator of the server 115B to control the functions of the server 115B. The server system 115 may execute, by the processor 115D, an operating system (O/S) and at least one instance of a servlet program (each stored in memory 115E).

The server system 115 may generate, store, train, or use a machine-learning model, configured to determine an electronic communication priority. The server system 115 may include a machine-learning model and/or instructions associated with the machine-learning model, e.g., instructions for generating a machine-learning model, training the machine-learning model, using the machine-learning model, etc. The server system 115 may include instructions for processing natural language email instructions, e.g., based on the output of the machine-learning model, and/or operating the display 115C to output an action, e.g., as adjusted based on the machine-learning model. The server system 115 may include training data, e.g., a training electronic communication dataset, one or more labels, and/or one or more rules.

In some embodiments, a system or device other than the server system 115 is used to generate and/or train the machine-learning model. For example, such a system may include instructions for generating the machine-learning model, the training data and ground truth, and/or instructions for training the machine-learning model. A resulting trained machine-learning model may then be provided to the server system 115.

Generally, a machine-learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine-learning model, e.g., compare the output of the trained model with the ground truth for that portion of the training data to evaluate an accuracy of the trained model. The training of the machine-learning model may be configured to cause the machine-learning model to learn associations between the electronic communication dataset, labels, and rules, such that the trained machine-learning model is configured to determine a priority for an electronic communication based on the learned associations.

In various embodiments, the variables of a machine-learning model may be interrelated in any suitable arrangement in order to generate the output. For example, the machine-learning model may include one or more convolutional neural network (“CNN”) configured to determine an email priority, and may include further architecture, e.g., a connected layer, neural network, etc., configured to determine a relationship between the identified features in order to determine a priority for an email communication.

Further aspects of the machine-learning model and/or how it may be utilized to process natural language email queries in further detail in the method below. In the following methods, various acts may be described as performed or executed by a component from FIG. 1, such as the server system 115, the user device 105, or components thereof. However, it should be understood that in various embodiments, various components of the environment 100 discussed below may execute instructions or perform acts including the acts discussed below. An act performed by a device may be considered to be performed by a processor, actuator, or the like associated with that device. Further, it should be understood that in various embodiments, various steps may be added, omitted, and/or rearranged in any suitable manner.

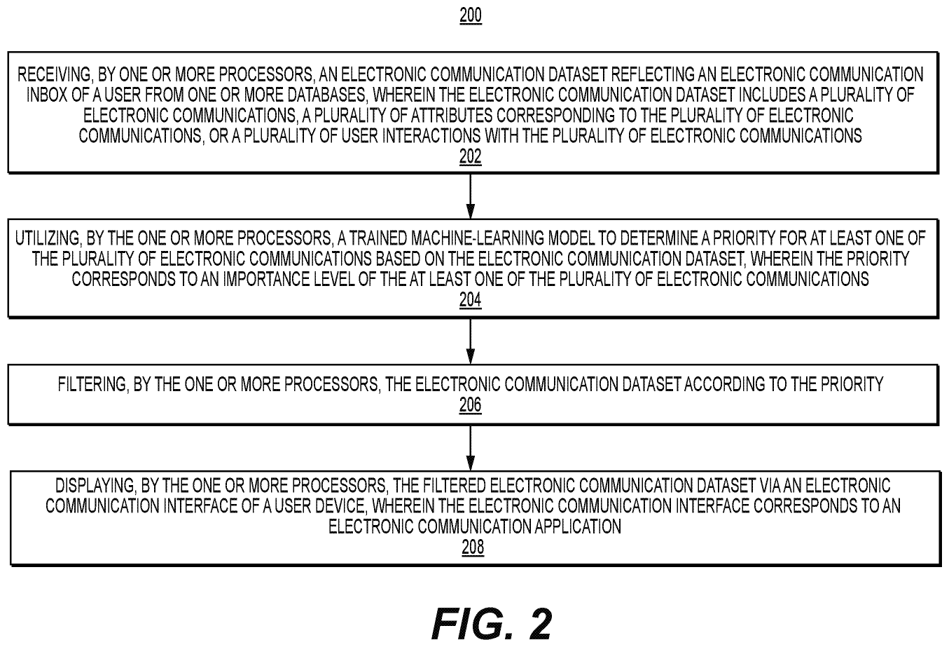

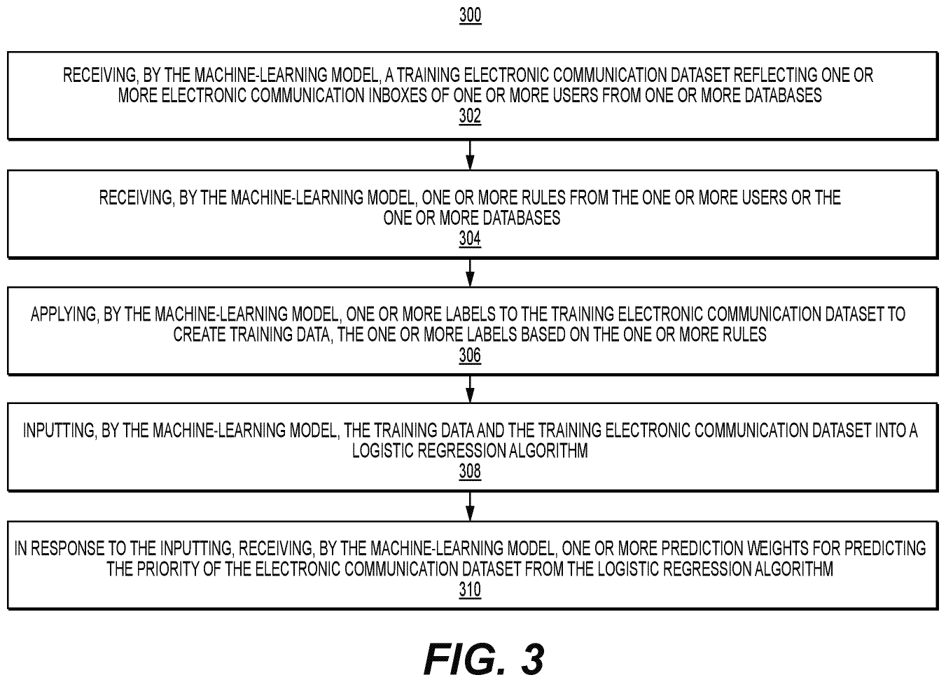

In general, any process or operation discussed in this disclosure that is understood to be computer-implementable, such as the process illustrated in FIGS. 2 and 3, may be performed by one or more processors of a computer system, such as any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples below, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

Although depicted as separate components in FIG. 1, it should be understood that a component or portion of a component in the environment 100 may, in some embodiments, be integrated with or incorporated into one or more other components. For example, a portion of the display 115C may be integrated into the user device 105 or the like. In some embodiments, operations or aspects of one or more of the components discussed above may be distributed amongst one or more other components. Any suitable arrangement and/or integration of the various systems and devices of the environment 100 may be used.

### Exemplary Method for Determining an Electronic Communication Priority

FIG. 2 depicts a flowchart of an exemplary method 200 for utilizing a machine-learning model to determine an electronic communication priority, according to one or more embodiments. Method 200 may be performed by one or more processors of a server that is in communication with one or more user devices and other external system(s) via a network. However, it should be noted that method 200 may be performed by any one or more of the server, one or more user devices, or other external systems.

The method may include receiving, by one or more processors, an electronic communication dataset reflecting an electronic communication inbox of a user from one or more databases, wherein the electronic communication dataset includes a plurality of electronic communications, a plurality of attributes corresponding to the plurality of electronic communications, or a plurality of user interactions with the plurality of electronic communications (Step 202). The electronic communication inbox may correspond to an email inbox, where the email inbox includes received emails, sent emails, saved emails, email drafts, email folders, and the like. The electronic communication dataset may include data that corresponds to some or all of the email inbox. For example, the electronic communication dataset may include a subset of data (e.g., a subset of emails and corresponding email data) of the email inbox. The electronic communication dataset may include a snapshot of the email inbox, where the snapshot reflects the email inbox at a particular point in time (e.g., emails, folders, email history, user preferences, and the like). In some embodiments, the snapshot reflects a subset of the data included in the email inbox. In some embodiments, the electronic communication dataset may only include emails and corresponding email attributes of emails that do not have a priority designation.

The one or more databases may store data corresponding to the email inbox, such as one or more snapshots. The databases may be updated periodically, where, for example, a new snapshot reflecting the most current email inbox data may be added to one or more databases. The databases may store historical email data, such as previous important emails, previous email statistics (e.g., important email receivers, important email senders, important email conversations and topics), previously sent emails, and/or previously received emails.

The electronic communication dataset may include a plurality of electronic communications, a plurality of attributes corresponding to the plurality of electronic communications, or a plurality of user interactions with the plurality of electronic communications. In some embodiments, a machine-learning model may analyze the electronic communication dataset to determine at least one of the plurality of attributes or at least one of the plurality of user interactions. The electronic communications may include one or more emails, responses to meeting invitations, and the like.

The plurality of attributes may include at least one of: a date, at least one sender, at least one receiver, a subject, a body, a tone, a topic, an electronic communication type, a number of electronic communications sent from the at least one receiver to the user, a number of electronic communications opened by the user, a number of electronic communications starred by the user, a number of electronic communications forwarded by the user, a number of electronic communications replied to by the user, or a number of electronic communications trashed by the user without opening. The date may correspond to a timestamp of when an email was sent or received. The at least one sender may correspond to one or more other users who sent the user an email. The at least one receiver may correspond to one or more other users who received an email sent by the user. The subject may correspond to the text of a subject line of an email. The body may correspond to the text of a body of an email. The tone may include at least one of: a persuasive tone, a friendly tone, a direct tone, an apologetic tone, a conciliatory tone, an encouraging tone, a respectful tone, an optimistic tone, a urgent tone, an informal tone, a business-like tone, an empathetic tone, a sincere tone, a formal tone, a neutral tone, or an official tone. The topic may correspond to one or more topics of the email, which may be determined by analyzing the body and subject of the email. The electronic communication type may include a personal type, a professional type, an event type, or an education type. The personal type may correspond to emails that relate to personal matters of the user, such as emails to/from friends, relatives, and the like. The professional type may correspond to emails that relate to professional matters of the user, such as emails to/from co-workers, users in professional organizations, and the like. The event type may correspond to emails that relate to events, such as calendar invitations and the like. The education type may correspond to emails that relate to educational matters of the user, such as emails to/from teachers, professors, students, and the like.

The plurality of user interactions with the plurality of electronic communications may include at least one of: a number of electronic communications sent by the at least one sender to the user, a number of electronic communications sent by the user to at least one receiver, a number of electronic communications opened by the user, a number of electronic communications starred by the user, a number of electronic communications forwarded by the user, a number of electronic communications replied to by the user, or a number of electronic communications trashed by the user without opening.

The number of electronic communications sent by the at least one sender to the user may include an amount and corresponding details of email correspondence received from at least one receiver by the user of the inbox. The number of electronic communications sent by the user to at least one receiver may include an amount and corresponding details of email correspondence sent by the user of the email inbox to the at least one receiver. The number of electronic communications opened by the user may include an amount and corresponding details of emails opened by the user of the email inbox. The number of electronic communications starred by the user may include an amount and corresponding details of emails starred/marked important by the user of the email inbox. The number of electronic communications forwarded by the user may include an amount and corresponding details of emails received by the user and then forwarded by the user to another receiver. The number of electronic communications replied to by the user may include an amount and corresponding details of emails received by the user and then replied to by the user. The number of electronic communications trashed by the user without opening may include an amount and corresponding details of emails that the user received and deleted without opening.

In some embodiments, the method may further include analyzing, by the machine-learning model, the plurality of electronic communications to determine the tone corresponding to each of the plurality of electronic communications, and storing, by the one or more processors, the tone for each of the plurality of electronic communications in the one or more databases. The machine-learning model may have been previously trained to analyze an email to determine a tone of the email. Upon determining a tone of the email, the system may store the email and the corresponding tone in the one or more databases.

In some embodiments, the method may further include analyzing, by the machine-learning model, the plurality of electronic communications to determine relationship data between the user and one or more contacts, wherein the one or more contacts include the at least one receiver or the at least one sender. The machine-learning model may have been previously trained to determine the relationship between the user and the one or more contacts. The machine-learning model may analyze the email address of the one or more contacts (e.g., the sender or the receiver), the subject, the tone, the body, and other content of the email to determine the relationship. For example, the machine-learning model may determine that the relationship between the user and at least one of the one or more contacts includes a professor/student relationship, where the user may be the student and the contact may be the professor. The machine-learning model may have determined such a relationship because the contact's email address may have been an “.edu” address, the email correspondence may have included a respectful tone from the user to the contact, and the email body may have included the contact's email signature that includes “Professor” as the contact's title.

The relationship data may include at least one of: a contact (e.g., a receiver, a sender), a number of sent electronic communications, a number of received electronic communications, a number of opened electronic communications, a number of starred electronic communications, or a number of forwarded electronic communications. The contact may include the contact's name, email address, and the like. The number of sent electronic communications may correspond to the amount of emails sent from the user to the contact. The number of received electronic communications may correspond to the amount of emails the user received from the contact. The number of opened electronic communications may correspond to the amount of emails, which are from the contact, that the user opens. The number of starred electronic communications may correspond to the amount of emails that are received from the contact or are sent to the contact, which the user starred/marked as important. The number of forwarded electronic communications may correspond to the amount of emails that are received from the contact or are sent to the contact, which the user forwarded to another contact. In some embodiments, the number of emails that are sent, received, opened, starred, or forwarded may be determine with respect to a specific period of time. For example, the number of sent electronic communications may correspond to an amount of emails that were sent over a specific period of time (e.g., a day, a month, a year).

The method may further include, based on the analyzing, updating, by the one or more processors, the one or more databases with the relationship data. A database may have previously stored relationship data, but a change in the relationship may have occurred after storing the relationship data. For example, the user may have previously opened all emails from a particular contact, but the user may no longer open emails from such contact. The system may update the database to include the most recent relationship data.

In some embodiments, one or more neural networks (e.g., using generative AI) may create/update the electronic communication dataset. The neural networks may analyze the electronic communication inbox based on the plurality of attributes to create the electronic communication dataset. The neural networks may then store the electronic communication dataset in the one or more databases. If an electronic communication dataset was previously created and stored, the neural networks may also analyze the electronic communication inbox based on the plurality of attributes to update the electronic communication dataset.

The method may further include utilizing, by the one or more processors, a trained machine-learning model to determine a priority for at least one of the plurality of electronic communications based on the electronic communication dataset, wherein the priority corresponds to an importance level of the at least one of the plurality of electronic communications (Step 204). The machine-learning model may include a logic learning model (LLM). For example, as discussed below, the trained machine-learning model may apply one or more prediction weights to the electronic communications to determine a priority for the electronic communications.

As discussed in the next section, a machine-learning model may have been previously trained to determine a priority for emails in the electronic communication dataset (e.g., an email subset). The trained machine-learning model may receive the electronic communication dataset and determine a priority for each of the emails included in the electronic communication dataset. The priority may correspond to an importance level for each email. For example, the priority may include an “important” or “unimportant” designation. Additionally, or alternatively, the priority may include a numerical designation indicating the priority. For example, the priority may include a number on a scale of 1 to 10, where a “1” indicates a low priority and a “10” indicates a high priority.

In some embodiments, the electronic communication dataset may include emails that already have a previously assigned priority. The trained machine-learning model may determine which (if any) emails already have a priority and skip such emails during the priority determination process. Additionally, or alternatively, the trained machine-learning model may re-analyze the emails that already have a priority and determine whether the priority should be updated. In some embodiments, the electronic communication dataset may have been previously filtered to remove emails that already include a priority.

The method may further include filtering, by the one or more processors, the electronic communication dataset according to the priority (Step 206). The filtering may include re-sorting the emails so that the emails with a higher priority (e.g., “important”) are at the top of the electronic communication dataset, where the emails with a lower priority (e.g., “unimportant”) are at the bottom of the electronic communication dataset. Additionally, or alternatively, the filtering may include isolating the emails with a higher priority (e.g., “important”) by removing the emails with the lower priority from the electronic communication dataset. Additionally, or alternatively, the filtering may include isolating the emails with a lower priority (e.g., “unimportant”) by removing the emails with the higher priority from the electronic communication dataset.

The method may further include displaying, by the one or more processors, the filtered electronic communication dataset via an electronic communication interface of a user device, wherein the electronic communication interface corresponds to an electronic communication application (Step 208). The electronic communication interface may correspond to an email inbox interface, where the electronic communication application may correspond to an email application. The filtered electronic communication dataset may be displayed according to the filtered order. For example, if the emails with the highest priority are first in the filtered order, the emails with the highest priority may be displayed first on the electronic communication interface. The isolated emails (e.g., emails with a low priority) may be omitted from the electronic communication interface and/or displayed on an electronic communication interface that is different from the emails that were not isolated (e.g., emails with a high priority). The emails may be displayed on the electronic communication interface with a corresponding priority designation (e.g., an “important” label, an “unimportant” label, a numerical value).

In some embodiments, the method may further include receiving, by the one or more processors, feedback from the user, wherein the feedback corresponds to an updated priority of at least one of the plurality of electronic communications. When displaying the filtered electronic communication dataset, the system may also display a feedback indicator, where the feedback indicator may be configured to receive feedback from the user. Exemplary feedback indicators may include a text box, a thumbs up graphical widget, a thumbs down graphical widget, and the like. The user may interact with a feedback indicator to indicate whether the trained machine-learning model correctly determined the priority for a particular email. Upon receiving the feedback from the user, the method may further include storing the feedback in one or more databases. The feedback may be stored with a corresponding reference to the particular email. The method may further include retraining, by the one or more processors, the trained machine-learning model based on the feedback. As discussed below, the trained machine-learning model may be trained using a training data set. The training data set may be updated using the feedback from the user, resulting in retraining the trained machine-learning model.

In some embodiments, the method may also include displaying, by the one or more processors, a priority query indicator configured to provide an explanation regarding the reasoning for why an email received a particular priority designation. The user may select the priority query indicator for an email, and in response to the selection, a reasoning for why the email received the priority designation may be displayed. For example, a user interface may display “this email was given an ‘important’ priority because you have opened 90% of the emails from the contact.”

Although FIG. 2 shows example blocks of exemplary method 200, in some implementations, the exemplary method 200 may include additional blocks, fewer blocks, different blocks, or differently arranged blocks than those depicted in FIG. 2. Additionally, or alternatively, two or more of the blocks of the exemplary method 200 may be performed in parallel.

### Exemplary Method for Training a Machine-Learning Model to Determine a Priority

FIG. 3 depicts a flowchart of an exemplary method 300 for utilizing a machine-learning model to determine an electronic communication priority, according to one or more embodiments. Method 300 may be performed by one or more processors of a server that is in communication with one or more user devices and other external system(s) via a network. However, it should be noted that method 300 may be performed by any one or more of the server, one or more user devices, or other external systems.

The method may include receiving, by the machine-learning model, a training electronic communication dataset reflecting one or more electronic communication inboxes of one or more users from one or more databases (Step 302). The machine-learning model may include a logic learning model (LLM). The training electronic communication dataset may include a plurality of emails and corresponding attributes (as described above). The user electronic communication inboxes may correspond to the email inboxes of one or more users, where the email inboxes include received emails, sent emails, saved emails, email drafts, email folders, and the like. The training electronic communication dataset may include a subset of the user electronic communication inboxes. For example, the training electronic communication dataset may include a subset of emails from the user electronic communication inboxes.

The method may further include receiving, by the machine-learning model, one or more rules from the one or more users or the one or more databases (Step 304). The users may create or modify the rules by inputting natural language text into the system. For example, a user may input “emails from Mr. Jones regarding upcoming meetings are very important.” The user may also input “emails from Mr. Jones regarding preparing the schedule are not important.” The rules from the user may be input by the user in real-time or previously input and stored in the one or more databases. In some embodiments, the machine-learning model may create one or more rules by analyzing the training electronic communication dataset for similarities, patterns, and the like.

The one or more rules may include default rules, personalized rules, and/or generic rules that may have not been input (or updated) by the user. The default rules may correspond to rules that have default values and may not be specific towards the user. For example, a default rule may state that a starred email should be labeled as “important.” The personalized rules may correspond to rules that are based on the user's interactions. For example, a personalized rule may state that emails from Mrs. Jones should be labeled as “important,” where the personalized rule may be based on the user always opening, and frequently starring, emails from Mr. Jones. The generic rules may correspond to rules that may not be specific towards the user. For example, a generic rule may state that emails from social media networks should be labeled as “unimportant.” The default rules and/or generic rules may become personalized rules after the electronic communication inbox has been analyzed, or after the user inputs a rule that overrides a default rule or a generic rule. In some embodiments, receiving the one or more rules may include updating at least one of the one or more rules.

In some embodiments, receiving the one or more rules may include receiving updated rules from the user or the one or more databases. For example, the user may provide feedback via a feedback indicator, where the feedback may correspond to the accuracy of a rule. For example, the user may give feedback that an email was correctly prioritized (confirming the accuracy of the rule). Additionally, for example, the user may give feedback that an email was incorrectly prioritized (indicating that a rule was not accurate). In such a situation, the user may also provide feedback indicating why an email was incorrectly prioritized. Based on the user feedback, the method may include updating the one or more rules, where the updated rules may be stored in the one or more databases and utilized for the following training steps to retrain the machine-learning model.

In some embodiments, the machine-learning model may convert the natural language rules into a format understood by a logistic regression algorithm. The logistic regression algorithm may not be able to understand natural language, so the machine-learning model may act as a “translator” to convert the natural language rules into a format that the logistic regression may be able to receive and understand.

The method may further include applying, by the machine-learning model, one or more labels to the training electronic communication dataset to create training data, the one or more labels based on the one or more rules (Step 306). The machine-learning model may analyze the training subset using the one or more rules to determine a label for each email in the subset. The labels may correspond to a priority designation for each of the emails. The one or more labels may include an important label and an unimportant label. Additionally, or alternatively, the one or more labels may include a numerical priority level, such as a “1” for indicating a low priority and a “10” for indicating a high priority. For example, if the user input the following rule, “emails from Mr. Jones regarding upcoming meetings are very important,” the machine-learning model may analyze the training subset for emails from Mr. Jones that reference an upcoming meeting. The machine-learning model may then label any email from Mr. Jones that references an upcoming meeting as “important.”

The method may further include inputting, by the machine-learning model, the training data and the training electronic communication dataset into a logistic regression algorithm (Step 308). The logistic regression algorithm may analyze the training data to determine the relationships between the emails of the training subsets and the labels. The logistic regression algorithm may then apply the analysis to the training electronic communication dataset to determine a priority for each of the emails in the training electronic communication dataset. Additionally, by determining a priority, the logistic regression algorithm may determine one or more prediction weights, which may reflect a relationship between an email and a priority of the email.

The method may further include, in response to the inputting, receiving, by the machine-learning model, one or more prediction weights for predicting the priority of the electronic communication dataset from the logistic regression algorithm (Step 310). The prediction weights may correspond to a priority weight, where an email with a higher priority may have a higher weight, and an email with a lower priority may have a lower weight. The logistic regression algorithm may output the prediction weights to the machine-learning model, where the prediction weights may be utilized for determining a priority of a future email. The prediction weights may be stored for use in a future priority determination, such as the process described in relation to FIG. 2.

Although FIG. 3 shows example blocks of exemplary method 300, in some implementations, the exemplary method 300 may include additional blocks, fewer blocks, different blocks, or differently arranged blocks than those depicted in FIG. 3. Additionally, or alternatively, two or more of the blocks of the exemplary method 300 may be performed in parallel.

### Exemplary Device

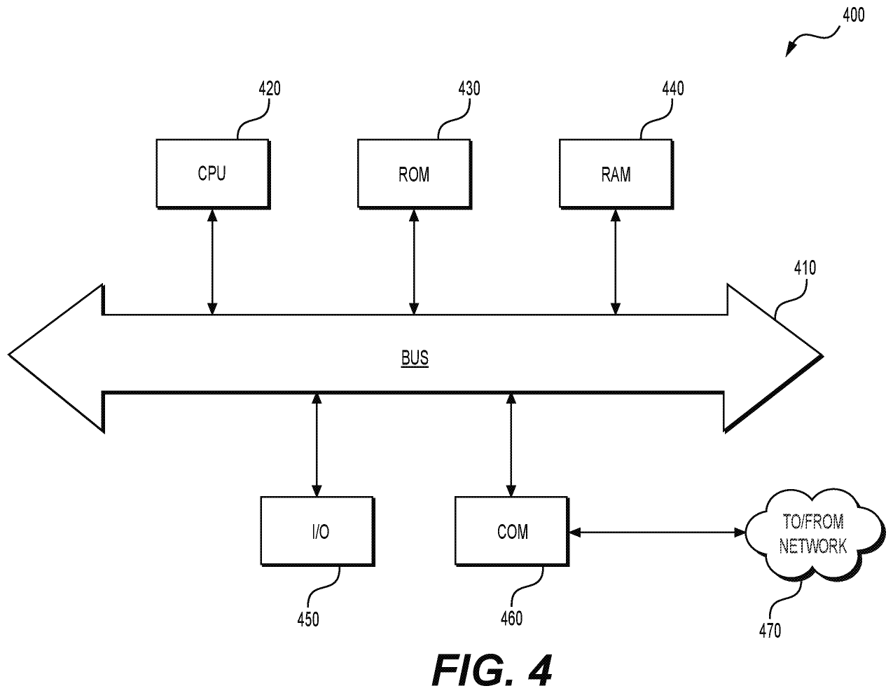

FIG. 4 is a simplified functional block diagram of a computer 400 that may be configured as a device for executing the methods of FIGS. 2 and 3, according to exemplary embodiments of the present disclosure. For example, device 400 may include a central processing unit (CPU) 420. CPU 420 may be any type of processor device including, for example, any type of special purpose or a general-purpose microprocessor device. As will be appreciated by persons skilled in the relevant art, CPU 420 also may be a single processor in a multi-core/multiprocessor system, such system operating alone, or in a cluster of computing devices operating in a cluster or server farm. CPU 420 may be connected to a data communication infrastructure 410, for example, a bus, message queue, network, or multi-core message-passing scheme.

Device 400 also may include a main memory 440, for example, random access memory (RAM), and also may include a secondary memory 430. Secondary memory 430, e.g., a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage unit may comprise a floppy disk, magnetic tape, optical disk, etc., which is read by and written to by the removable storage drive. As will be appreciated by persons skilled in the relevant art, such a removable storage unit generally includes a computer usable storage medium having stored therein computer software and/or data.

In alternative implementations, secondary memory 430 may include other similar means for allowing computer programs or other instructions to be loaded into device 400. Examples of such means may include a program cartridge and cartridge interface (such as that found in video game devices), a removable memory chip (such as an EPROM, or PROM) and associated socket, and other removable storage units and interfaces, which allow software and data to be transferred from a removable storage unit to device 400.

Device 400 also may include a communications interface (“COM”) 460. Communications interface 460 allows software and data to be transferred between device 400 and external devices. Communications interface 460 may include a modem, a network interface (such as an Ethernet card), a communications port, a PCMCIA slot and card, or the like. Software and data transferred via communications interface 460 may be in the form of signals, which may be electronic, electromagnetic, optical, or other signals capable of being received by communications interface 460. These signals may be provided to communications interface 460 via a communications path of device 400, which may be implemented using, for example, wire or cable, fiber optics, a phone line, a cellular phone link, an RF link or other communications channels.

The hardware elements, operating systems and programming languages of such equipment are conventional in nature, and it is presumed that those skilled in the art are adequately familiar therewith. Device 400 also may include input and output ports 450 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the general description and the detailed description are exemplary and explanatory only and are not restrictive of the features, as claimed.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for utilizing a machine-learning model to determine an electronic communication priority, the computer-implemented method comprising:
receiving, by one or more processors, an electronic communication dataset reflecting an electronic communication inbox of a user from one or more databases, wherein the electronic communication dataset includes a plurality of electronic communications, a plurality of attributes corresponding to the plurality of electronic communications, or a plurality of user interactions with the plurality of electronic communications;
utilizing, by the one or more processors, a trained machine-learning model to determine a priority for at least one of the plurality of electronic communications based on the electronic communication dataset, wherein the priority corresponds to an importance level of the at least one of the plurality of electronic communications;
filtering, by the one or more processors, the electronic communication dataset according to the priority; and
displaying, by the one or more processors, the filtered electronic communication dataset via an electronic communication interface of a user device, wherein the electronic communication interface corresponds to an electronic communication application.

2. The computer-implemented method of claim 1, wherein the plurality of attributes include at least one of: a date, at least one sender, at least one receiver, a subject, a body, a tone, an electronic communication type, or a topic.

3. The computer-implemented method of claim 2, wherein the tone includes at least one of: a persuasive tone, a friendly tone, a direct tone, an apologetic tone, a conciliatory tone, an encouraging tone, a respectful tone, an optimistic tone, a urgent tone, an informal tone, a business-like tone, an empathetic tone, a sincere tone, a formal tone, a neutral tone, or an official tone.

4. The computer-implemented method of claim 2, the computer-implemented method further comprising:
analyzing, by the machine-learning model, the plurality of electronic communications to determine the tone corresponding to each of the plurality of electronic communications; and
storing, by the one or more processors, the tone for each of the plurality of electronic communications in the one or more databases.

5. The computer-implemented method of claim 2, the computer-implemented method further comprising:
analyzing, by the machine-learning model, the plurality of electronic communications to determine relationship data between the user and one or more contacts, wherein the one or more contacts include the at least one receiver or the at least one sender; and
based on the analyzing, updating, by the one or more processors, the one or more databases with the relationship data.

6. The computer-implemented method of claim 5, wherein the relationship data includes at least one of: a contact, a number of sent electronic communications, a number of received electronic communications, a number of opened electronic communications, a number of starred electronic communications, or a number of forwarded electronic communications.

7. The computer-implemented method of claim 1, wherein the trained machine-learning model was previously trained to determine the priority for the at least one of the plurality of electronic communications, wherein the training comprises:
receiving, by the machine-learning model, a training electronic communication dataset reflecting one or more electronic communication inboxes of one or more users from one or more databases;
receiving, by the machine-learning model, one or more rules from the one or more users or the one or more databases;
applying, by the machine-learning model, one or more labels to the training electronic communication dataset to create training data, the one or more labels based on the one or more rules;
inputting, by the machine-learning model, the training data and the training electronic communication dataset into a logistic regression algorithm; and
in response to the inputting, receiving, by the machine-learning model, one or more prediction weights for predicting the priority of the electronic communication dataset from the logistic regression algorithm.

8. The computer-implemented method of claim 7, wherein the machine-learning model includes a logic learning model (LLM).

9. The computer-implemented method of claim 7, wherein the one or more labels include an important label and an unimportant label.

10. The computer-implemented method of claim 1, the computer-implemented method further comprising:
receiving, by the one or more processors, feedback from the user, wherein the feedback corresponds to an updated priority of at least one of the plurality of electronic communications; and
retraining, by the one or more processors, the trained machine-learning model based on the feedback.

11. A computer system for utilizing a machine-learning model to determine an electronic communication priority, the computer system comprising:
a memory having processor-readable instructions stored therein; and
one or more processors configured to access the memory and execute the processor-readable instructions, which when executed by the one or more processors configures the one or more processors to perform a plurality of functions, including functions for:
receiving an electronic communication dataset reflecting an electronic communication inbox of a user from one or more databases, wherein the electronic communication dataset includes a plurality of electronic communications, a plurality of attributes corresponding to the plurality of electronic communications, or a plurality of user interactions with the plurality of electronic communications;
utilizing a trained machine-learning model to determine a priority for at least one of the plurality of electronic communications based on the electronic communication dataset, wherein the priority corresponds to an importance level of the at least one of the plurality of electronic communications;
filtering the electronic communication dataset according to the priority; and
displaying the filtered electronic communication dataset via an electronic communication interface of a user device, wherein the electronic communication interface corresponds to an electronic communication application.

12. The computer system of claim 11, wherein the plurality of attributes include at least one of: a date, at least one sender, at least one receiver, a subject, a body, a tone, an electronic communication type, or a topic.

13. The computer system of claim 12, wherein the tone includes at least one of: a persuasive tone, a friendly tone, a direct tone, an apologetic tone, a conciliatory tone, an encouraging tone, a respectful tone, an optimistic tone, a urgent tone, an informal tone, a business-like tone, an empathetic tone, a sincere tone, a formal tone, a neutral tone, or an official tone.

14. The computer system of claim 12, the functions further comprising:
analyzing, by the machine-learning model, the plurality of electronic communications to determine the tone corresponding to each of the plurality of electronic communications; and
storing the tone for each of the plurality of electronic communications in the one or more databases.

15. The computer system of claim 12, the functions further comprising:
analyzing, by the machine-learning model, the plurality of electronic communications to determine relationship data between the user and one or more contacts, wherein the one or more contacts include the at least one receiver or the at least one sender; and
based on the analyzing, updating the one or more databases with the relationship data.

16. A non-transitory computer-readable medium containing instructions for utilizing a machine-learning model to determine an electronic communication priority, the instructions comprising:
receiving an electronic communication dataset reflecting an electronic communication inbox of a user from one or more databases, wherein the electronic communication dataset includes a plurality of electronic communications, a plurality of attributes corresponding to the plurality of electronic communications, or a plurality of user interactions with the plurality of electronic communications;
utilizing a trained machine-learning model to determine a priority for at least one of the plurality of electronic communications based on the electronic communication dataset, wherein the priority corresponds to an importance level of the at least one of the plurality of electronic communications;
filtering the electronic communication dataset according to the priority; and
displaying the filtered electronic communication dataset via an electronic communication interface of a user device, wherein the electronic communication interface corresponds to an electronic communication application.

17. The non-transitory computer-readable medium of claim 16, wherein the trained machine-learning model was previously trained to determine the priority for the at least one of the plurality of electronic communications, wherein the training comprises:
receiving, by the machine-learning model, pa training electronic communication dataset reflecting one or more electronic communication inboxes of one or more users from one or more databases;
receiving, by the machine-learning model, one or more rules from the one or more users or the one or more databases;
applying, by the machine-learning model, one or more labels to the training electronic communication dataset to create training data, the one or more labels based on the one or more rules;
inputting, by the machine-learning model, the training data and the training electronic communication dataset into a logistic regression algorithm; and
in response to the inputting, receiving, by the machine-learning model, one or more prediction weights for predicting the priority of the electronic communication dataset from the logistic regression algorithm.

18. The non-transitory computer-readable medium of claim 17, wherein the machine-learning model includes a logic learning model (LLM).

19. The non-transitory computer-readable medium of claim 17, wherein the one or more labels include an important label and an unimportant label.

20. The non-transitory computer-readable medium of claim 16, the instructions further comprising:
receiving feedback from the user, wherein the feedback corresponds to an updated priority of at least one of the plurality of electronic communications; and
retraining the trained machine-learning model based on the feedback.
